(19) United States
(12) Patent Application Publication
(10) Pub. No.: US 2010/0318889 A1
(43) Pub. Date: Dec. 16, 2010

(54) Automatic Insertion of Data from Web Forms into Documents

(75) Inventors: Alan Billharz, Kirkland, WA (US); Michael Monarch, Hingham, MA (US); Marta Rey-Babarro, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/483,670

(22) Filed: Jun. 12, 2009

(51) Int. Cl. G06F 17/00

(52) U.S. Cl. 715/212; 715/225

(57) ABSTRACT

A host computing system automatically inserts data submitted from web forms into documents. The host computing system stores a document file comprising data that represents a document. The document comprises at least one document element. The host computing system receives a block of web form data. The block of web form data comprises a value assigned to a web form element in a web form. In response to receiving the block of web form data, the host computing system automatically updates the document element to specify the value when the document file comprises element mapping metadata that maps the document element to the web form element.

### BACKGROUND

A web form is a web page that allows a user to enter data that is sent to a server for processing. Web forms enable individuals and organizations to collect information from users. For example, an enterprise can use a web form to collect the names and addresses of people who are planning to attend an event. Web forms contain one or more web form elements. A web form element is an element of a web form, the element having a name and a value that is submitted to a server when the web form is submitted. Example types of web form elements include text boxes, drop boxes, radio buttons, check boxes, file selection boxes, password entry boxes, text areas, hidden fields, and so on.

When a user submits a web form, the values assigned to the web form elements in the web form are processed by a script. In one typical case, the script stores into a database the values assigned to the web form elements of the web form. In another typical case, the script sends to an administrator an e-mail message containing the values assigned to the web form elements of the web form.

After the script has processed the values assigned to the web form elements, a user may manually enter the values into various kinds of documents. For example, the user may manually enter the values into a word processor document, a spreadsheet document, or another type of document. Manually entering the values into documents may be laborious, time consuming, and expensive.

### SUMMARY

In one example, a host computing system automatically inserts data from web forms into documents. The host computing system stores a document file comprising data that represents a document. The document comprises at least one document element. The host computing system receives a block of web form data. The block of web form data comprises a value assigned to a web form element in a web form. In response to receiving the block of web form data, the host computing system automatically updates the document element to specify the value when the document file comprises element mapping metadata that maps the document element to the web form element.

This summary is provided to introduce a selection of concepts in a simplified form. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system in which documents are automatically updated with data from web forms.

FIG. 2 is a block diagram illustrating example logical components of a server computing system.

FIG. 3 is a block diagram illustrating example logical components of a host computing system.

FIG. 4 is a flowchart illustrating an example operation performed by an administrator to configure a document to be automatically updated based on data from a web form.

FIG. 5 is a flowchart illustrating an example operation performed by the host computing system to configure a document to be automatically updated based on data from a web form.

FIG. 6 is a flowchart illustrating an example alternate operation performed by the host computing system to configure a document to be automatically updated based on data from a web form.

FIG. 7 is a flowchart illustrating an example operation performed by the host computing system when the host computing system receives document open request.

FIG. 8 is a flowchart illustrating an example operation performed by the server computing to host the web form.

FIG. 9 is a flowchart illustrating an example operation performed by the server computing system to synchronize blocks of web form data with documents.

FIG. 10 is a block diagram illustrating example hardware details of an electronic computing device.

### DETAILED DESCRIPTION

As briefly described above, this disclosure is directed to a computing system that automatically updates documents with data from web forms. The techniques of this disclosure are described with reference to the attached figures. It should be appreciated that the attached figures are provided for purposes of explanation only and should not be understood as representing a sole way of implementing the techniques of this disclosure.

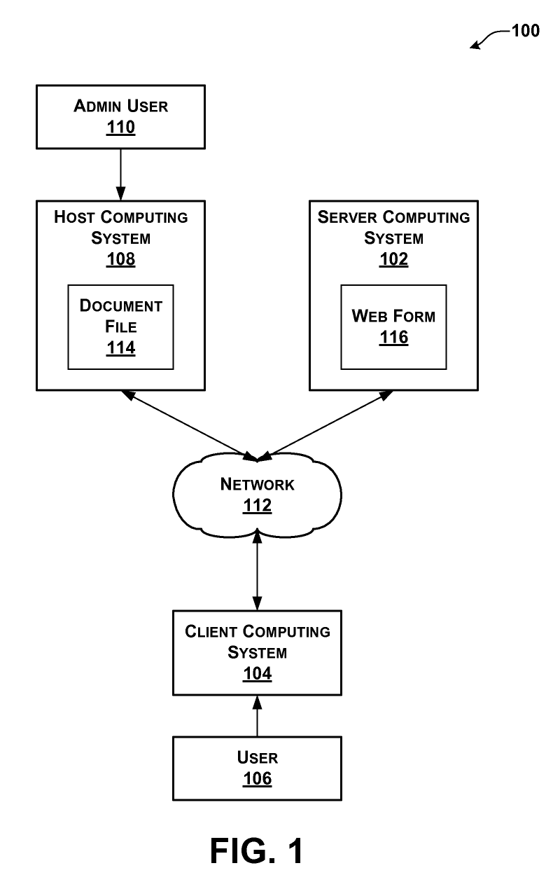

FIG. 1 is a block diagram illustrating an example system 100 in which documents are automatically updated with data from web forms. It should be appreciated that the system 100 is merely an example and that there may be many other systems that provide automatic updates to documents with data from web forms.

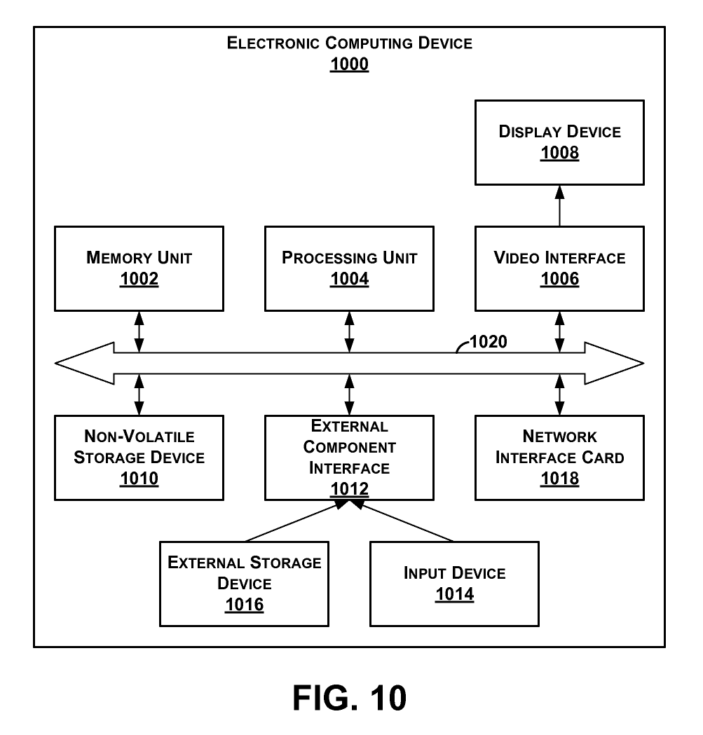

As illustrated in the example of FIG. 1, the system 100 includes a server computing system 102. The server computing system 102 is an electronic computing system. As used in this disclosure, an electronic computing system is a set of one or more physical electronic computing devices. An electronic computing device is a physical machine that comprises physical electronic components. Electronic components are physical entities that affect electrons or fields of electrons in a desired manner consistent with the intended function of an electronic computing device. Example types of electronic components include capacitors, resistors, diodes, transistors, and other types of physical entities that affect electrons or fields of electrons in a manner consistent with the intended function of an electronic computing device. An example physical computing device is described below with reference to FIG. 10.

In addition, the system 100 includes a client computing system 104. The client computing system 104 is an electronic computing system. The client computing system 104 and the client computing system 106 are electronic computing systems. The client computing system 104 may be a wide variety of different types of electronic computing systems. For example, the client computing system 104 may be a personal computer, a lap top computer, a cellular telephone, a smartphone, a watch, a video game console, a netbook, a personal media player, a device integrated into a vehicle, a television set top box, a network appliance, a server device, a supercomputer, a mainframe computer, or another type of electronic computing system.

A user 106 interacts with the client computing system 104. The user 106 is an individual human being. For example, the user 106 may be a customer of a small business. In another example, the user 106 may be a member of the public browsing the World Wide Web. The user 106 may be using the client computing system 104 on behalf of one or more enterprises. As used in this disclosure, an enterprise is a natural or legal entity. Example types of legal entities include corporations, partnerships, proprietorships, companies, non-profit corporations, foundations, estates, governmental agencies, and other types of legal entities.

The user 106 may interact with the client computing system 104 in a variety of ways. For example, the user 106 may use an input device, such as a keyboard or mouse, directly connected to the client computing system 104 to interact with the client computing system 104. In another example, the user 106 may interact with the client computing system 104 by interacting with a computing system (not shown) that communicates with the client computing system 104.

The system 100 also comprises a host computing system 108. The host computing system 108 is an electronic computing system. An administrator 110 interacts with the host computing system 108. The administrator 110 is an individual human being. The administrator 110 is referred to as an administrator to differentiate the administrator 110 from the user 106. The term administrator does not, in the context of this disclosure, imply any special technical skill or knowledge. The administrator 110 may interact with the host computing system 108 in a variety of ways. For example, the administrator 110 may use input devices, such as keyboards or mice, directly connected to the host computing system 108 to interact with the host computing system 108. In another example, the administrator 110 may interact with the host computing system 108 by interacting with computing systems (not shown) that communicate with the host computing system 108.

A network 112 facilitates communication between the server computing system 102, the client computing system 104, and the host computing system 108. The network 112 may be a wide variety of different types of electronic communication network. For example, the network 112 may be a wide-area network, such as the Internet, a local-area network, a metropolitan-area network, or another type of electronic communication network. The network 112 may include wired and/or wireless data links. A variety of communications protocols may be used in the network 112 including, but not limited to, Ethernet, Transport Control Protocol (TCP), Internet Protocol (IP), Hypertext Transfer Protocol (HTTP), SOAP, remote procedure call protocols, and/or other types of communications protocols. In some implementations, the server computing system 102, the client computing system 104, and/or the host computing system 108 communicate via the network 112 securely. For example, the server computing system 102, the client computing system 104, and/or the host computing system 108 use secure sockets layer (SSL) techniques to communicate securely over the network 112. In another example, the server computing system 102, the client computing system 104, and/or the host computing system 108 use IPSec to communicate securely over the network 112.

As illustrated in the example of FIG. 1, the host computing system 108 hosts a document file 114. As used in this disclosure, a document file is a discrete block of data that represents a document. Furthermore, as used in this disclosure, a document is a discrete set of human-readable content. Example types of documents include word processor documents, spreadsheet documents, text documents, slideshow documents, and other types of discrete sets of human-readable content. As used in this disclosure, a word processor document is a document comprising human-readable content (e.g., text) having a specific format that defines how the human-readable content is laid out when the document is physically printed. Moreover, as used in this disclosure, a spreadsheet document is a document in which human-readable content is represented as a table of data arranged in columns and rows. Furthermore, as used in this disclosure, a text document is a document containing human-readable text and not having a specific format that defines how the human-readable content is laid out when the document is physically printed. As used in this disclosure, a computing system hosts a resource (e.g., the document file 114) when the computing system enables one or more users and/or other computing systems to interact with the resource.

Although the document file 114 is, in the example of FIG. 1, stored at the host computing system 108, in some implementations, the server computing system 102 stores the document file 114. In such implementations, the host computing system 108 may interact with the document file 114 via the network 112.

This disclosure refers to the document represented by the document file 114 simply as the document. The document comprises at least one document element. As used in this disclosure, a document element is a logical sub-part of the human-readable content of a document. The document includes human-readable content other than the document element. In some example implementations, the document element is visibly differentiated from the human-readable content other than the document element. As used in this disclosure, a document element in a document is visibly differentiated from other parts of the document when a user is able to distinguish a boundary between the document element and the other parts of the document when the user is looking at the document.

Different types of documents can have different types of document elements. For instance, example types of document elements in a word processor document may include text boxes, check boxes, paragraphs, tables, list items, and other logical sub-parts of the human-readable content of a word processor document. In another instance, example types of document elements in a spreadsheet document may include individual rows, groups of rows, individual columns, groups of columns, and other logical sub-parts of the human-readable content of a spreadsheet document. As used in this disclosure, a text box is a container for text or graphics in a word processor document.

As illustrated in the example of FIG. 1, the server computing system 102 hosts a web form 116. As used in this disclosure, a web form is a web page that allows a user to enter data that is sent to a server for processing. As used in this disclosure, a web page is document that is suitable for the World Wide Web and can be accessed through a web browser and displayed on a computer screen. The web form 116 comprises at least one web form element. As used in this disclosure, a web form element is an element of a web form, the element having a name and a value that is submitted to a server when the web form is submitted. Example types of web form elements include text boxes, drop boxes, radio buttons, check boxes, file selection boxes, password entry boxes, text areas, hidden fields, and so on. Human or computers can assign the values of web form elements. For instance, a human can enter text into a text box in a web form when the web form is presented to the human. In another instance, a computer can assign the value of a hidden field using a script embedded in the web form. In still another instance, a human designing the web form can assign values to web form elements.

The user 106 interacts with the client computing system 104 to request a copy of the web form 116 from the server computing system 102. For example, the client computing system 104 may execute a web browser application. In this example, the user 106 may interact with the web browser application to select a link to the web form 116. When the user 106 interacts with the client computing system 104 to request the web form 116, the client computing system 104 sends a web form request to the server computing system 102 via the network 112. The web form request requests the server computing system 102 to send a copy of the web form 116 to the client computing system 104. Depending on the implementation of the system 100, the web form request may take a variety of forms. For example, the web form request may take the form of an HTTP request that indicates a domain name of the server computing system 102 and a resource path of the web form 116. In a second example, a word processor application executes on the client computing system 104. In this second example, the user 106 instructs the word processor application to request the web form 116. The word processor application, in this second example, responds by using a remote procedural call to send the web form request. In response to the web form request, the server computing system 102 sends a copy of the web form 116 to the client computing system 104.

When the client computing system 104 receives a copy of the web form 116, the client computing system 104 causes a display device (see, e.g., display device 1008 in FIG. 10) to display the copy of the web form 116, thereby enabling the user 106 to view the copy of the web form 116. After the client computing system 104 causes the display device to display the copy of the web form 116, the user 106 may enter data into one or more web form elements in the copy of the web form 116. It should be appreciated, however, that not all web forms have web form elements to which humans can assign values. For instance, all of the web form elements in a web form could be hidden fields. However, for the sake of explanation, it is assumed that the user 106 is able to assign data to at least one web form element in the web form 116.

After the user 106 assigns data to one or more web form elements in the copy of the web form 116, the client computing system 104 submits data assigned to the web form elements in the copy of the web form 116 to the server computing system 102 via the network 112. In this disclosure, the data assigned to the web form elements in the copy of the web form 116 is referred to as the block of web form data. The client computing system 104 may submit the block of web form data in response to a variety of events. For example, the client computing system 104 may submit the block of web form data when the user 106 selects a submit button in the copy of the web form 116. In another example, the client computing system 104 may automatically submit the block of web form data when a script embedded in the copy of the web form 116 determines that a timeout condition has occurred. It should be appreciated that in other implementations, the client computing system 104 does not necessarily submit the block of web form data to the same server computing system from which the client computing system 104 requested the copy of the web form 116. Rather, the web form 116 may include information indicating that the block of web form data is to be submitted to a different server computing system.

When the server computing system 102 receives the block of web form data, the server computing system 102 stores the block of web form data at a data storage system accessible to the server computing system 102. As used in this disclosure, a data storage system is a set of one or more computer-readable data storage media. Furthermore, as used in this disclosure, a computer-readable data storage medium is a physical device or article of manufacture capable of storing data that can be read by a computing system. Example types of computer-readable data storage media include hard disk drives, flash memory devices, floppy disks, read-only memory (ROM) units, random access memory (RAM) modules, optical discs (e.g., CD-ROMs, DVDs, BluRay discs, etc.), and other types of physical devices or articles of manufacture capable of storing data that can be read by a computing system.

In different implementations, the server computing system 102 stores the block of web form data in different ways. For example, the server computing system 102 may store the block of web form data in a database. In another example, the server computing system 102 may store the block of web form data in a cache.

After storing the block of web form data, the server computing system 102 sends the block of web form data to the host computing system 108. In various implementations, the server computing system 102 may send the block of web form data to the host computing system 108 in response to a variety of events. For example, the server computing system 102 may send the block of web form data to the host computing system 108 in response to receiving a web form data request from the host computing system 108. The web form data request requests the server computing system 102 to send one or more blocks of web form data associated with a particular web form to the host computing system 108. In this example, the web form data request may be formatted in a variety of ways. For instance, the web form data request may be a HTTP request, a remote procedure call, a file transfer protocol (FTP) request, a SOAP request, and so on. Furthermore, in this example, the host computing system 108 may send such web form data requests to the server computing system 102 via the network 112 on a periodic basis (e.g., once an hour). In another example, the server computing system 102 may send the block of web form data to the host computing system 108 without first receiving a web form data request from the host computing system 108.

As mentioned above, the document comprises at least one document element. Furthermore, as mentioned above, the block of web form data comprises at least one value assigned to a web form element in the web form 116. When the host computing system 108 receives the block of web form data, the host computing system 108 automatically inserts data based on the value into the document element of the document file 114 only when the document file 114 comprises element mapping metadata that maps the document element to the web form element. As used in this disclosure, element mapping metadata is metadata in a document, the metadata specifying a mapping between a document element within the document and a web form element within a web form. As used in this disclosure, metadata is data about other data. In general, the element mapping metadata is not displayed when the document file 114 is displayed. As used in this disclosure, inserting data into a document element of a document file entails causing the document file to contain data indicating that the value is in the document element. Furthermore, as used in this disclosure, automatically inserting data into a document element entails changing the data in the document file without human entry of data into the document file. Thus, no human activity is required to update the data in the document file 114 when the host computing system 108 receives the block of web form data. As used in this disclosure, data is based on a value when the data is the same as the value or when a transformation has been applied to the data. A transformation is a logical mapping from a first piece of data (e.g., the data) to a second piece of data.

In some example implementations, element mapping metadata that maps a document element to a web form element also indicates whether the value assigned to the web form element is to be appended to data specified by the document element or whether the value assigned to the web form element is to replace data specified by the document element.

It should be appreciated that in other implementations, the host computing system 108 may automatically generate a new copy of the document file 114 when the host computing system 108 receives the block of web form data. In such implementations, when the host computing system 108 generates the new copy of the document file 114, the new copy of the document file 114 contains the document element and the document element mapping metadata. The document element in the new copy of the document file 114 specifies the value in the block of web form data assigned to the web form element only when the element mapping metadata maps the document element to the web form element. In some such implementations, the element mapping metadata indicates whether the host computing system 108 is to create a new copy of the document file 114 in which a value in the block of web form data replaces the data specified by the web form element. Thus, when the host computing system 108 receives the block of web form data, the host computing system 108 automatically creates the new copy of the document file 114 when the element mapping metadata indicates that the host computing system 108 is to create the new copy of the document file 114.

The following examples help to illustrate the effects of automatically updating the document file 114 based on the block of web form data. In a first example, the document file 114 is a word processing document, the document element is a text box within the document file 114 and the document file 114 contains element mapping metadata that maps the text box to a text field element in the web form 116. In this first example, the host computing system 108 updates the document file 114 such that the text box specifies a value assigned to the text field element. For instance, in this first example, the user 106 may have assigned the value “Jackie Stevens” to the text field element in the web form 116. Consequently, in this instance, the host computing system 108 updates the document file 114 such that the text box in the document file 114 specifies “Jackie Stevens.” In another instance, the host computing system 108 applies a transformation to the value assigned to the text field element in the web form 116. For example, the transformation may replace names with initials. In this example, where the user 106 assigned the value “Jackie Stevens” to the text field element in the web form 116, the host computing system 108 updates the document file 114 such that the text box in the document file 114 specifies “JS”.

In a second example, the document file 114 is a word processing document, the document element is a check box within the document file 114, and the document file 114 contains element mapping metadata that maps the check box to a check box element in the web form 116. In this second example, the host computing system 108 updates the document file 114 such that the check box specifies a value assigned to the text field element. For instance, in this second example, the user 106 may have assigned the unchecked state to the check box element in the web form 116. Consequently, in this instance, the host computing system 108 updates the document file 114 such that the check box in the document file 114 specifies the unchecked state. As mentioned above, in some implementations, the host computing system 108 may apply a transformation to the value assigned to the text field element in the web form 116. In this example, the check box in the web form 116 may prompt the user 106 to indicate whether she is diabetic and the document element is a text box. In this instance, the host computing system 108 applies a transformation to the value assigned the check box such that the host computing system 108 inserts the words “Patient is diabetic” in the text box in the document file 114 when the check box specifies the checked state and the words “Patient is not diabetic” in the text box in the document file 114 when the check box specifies the unchecked state.

In a third example, the document file 114 is a spreadsheet document, the document element is a column in the document file 114, and the document file 114 contains element mapping metadata that maps the column to a hidden field in the web form 116. Furthermore, in this third example, the element mapping metadata specifies that a new value assigned to a web form element is to be added to a new row in the spreadsheet document. In this third example, the web form 116 includes a script that causes the client computing system 104 to assign automatically the current date to the hidden field. Thus, in this third example, the host computing system 108 updates the document file 114 such that a first empty cell in the column specifies the value specified by the hidden field (i.e., the current date).

After the host computing system 108 updates the document file 114, the host computing system 108 receives a document open request from the administrator 110. The document open request indicates that the administrator 110 wants to open the document file 114. As used in this disclosure, opening a document file entails retrieving from the document file a data storage system and presenting a document represented by the document file to a user. Furthermore, as used in this disclosure, presenting a document entails enabling, by a computing system, a human to physically perceive the document. This disclosure refers to a device that presents a document as a presentation device. A computing system may enable a human to physically perceive a document in a variety of ways. For instance, a computing system may enable a human to physically perceive a document by causing a display device to display at least some of the document. In another instance, a computing system may enable a human to physically perceive a document by causing an audio output system to audibly read content in the document.

In different implementations of the host computing system 108, the document open request assumes different forms. In a first example, an input device (e.g., mouse, keyboard, etc.) and a presentation device are directly attached to the host computing system 108. In this first example, the host computing system 108 causes the presentation device to present a user interface containing an icon representing the document file 114. Furthermore, in this first example, the host computing system 108 receives the document open request when the administrator 110 uses the input device to select the icon representing the document file 114. In this first example, when the host computing system 108 receives the document open request, the host computing system 108 causes the presentation device to present at least a portion of the document. In a second example, the host computing system 108 stores document files used by a plurality of users. In this second example, the administrator 110 directly interacts with a client computing system (not shown). Furthermore, in this second example, the client computing system sends the document open request to the host computing system 108 via an electronic communications network. In this second example, the host computing system 108 responds to the document open request by sending a copy of the document file 114 to the client computing system. Upon receiving the copy of the document file 114, the client computing system uses the copy of the document file 114 to cause a presentation device to present the document.

Depending on the type of the document file 114, a computing system may execute a variety of software applications that cause the computing system to present the document. In a first example, a computing system may execute a word processor application that causes the computing system to present the document. In a second example, a computing system may execute a spreadsheet application that causes the computing system to present the document. As used in this disclosure, a software application is a set of software instructions that, when executed by a processing unit of a computing system, cause the computing system to provide a computerized tool with which a user can interact. As used in this disclosure, a processing unit is a set of one or more physical integrated circuits capable of executing software instructions. As used in this disclosure, a software instruction is a data structure that represents an operation of a processing unit. For example, a software instruction may be a data structure comprising an operation code and zero or more operand specifiers. In this example, the operand specifiers may specify registers, memory addresses, or literal data. As used in this disclosure, a word processor application is a software application that enables a user to create, view, and edit word processor documents. Example types of word processor applications include the Microsoft Word word processing application, the Google Docs word processing application, the Open Office Writer word processing application, and so on. As used in this disclosure, a spreadsheet application is a software application that enables a user to create, view, and edit spreadsheet documents. Example types of spreadsheet applications include the EXCEL® spreadsheet software from Microsoft Corporation, the Google Docs spreadsheet application, the Open Office Calc spreadsheet application, and so on.

Because the host computing system 108 automatically updated the document file 114 before the document is presented to the administrator 110, it is not necessary for the administrator 110 to manually edit the document to include the values in the block of web form data. In some circumstances, not having to manually edit the document to include values in the block of the web form data may save the administrator 110 considerable amounts of time and money. Because the host computing system 108 automatically updated the document file 114 before the document is presented to the administrator 110, it is not necessary for the administrator 110 to manually edit the document to include the values in the block of web form data. In some circumstances, not having to manually edit the document to include values in the block of the web form data may save the administrator 110 considerable amounts of time and money. As described in detail below, the administrator 110 may, in some implementations, use one or more graphical user interfaces integrated into a document application to map web form elements to document elements. In this way, the administrator 110 may, in some example implementations, only need to be familiar with the document application to be able to configure document files such that data from web forms is automatically inserted into the document files. That is, in some implementations, the administrator 110 may not need to interact with a HTML editor application or perform any scripting.

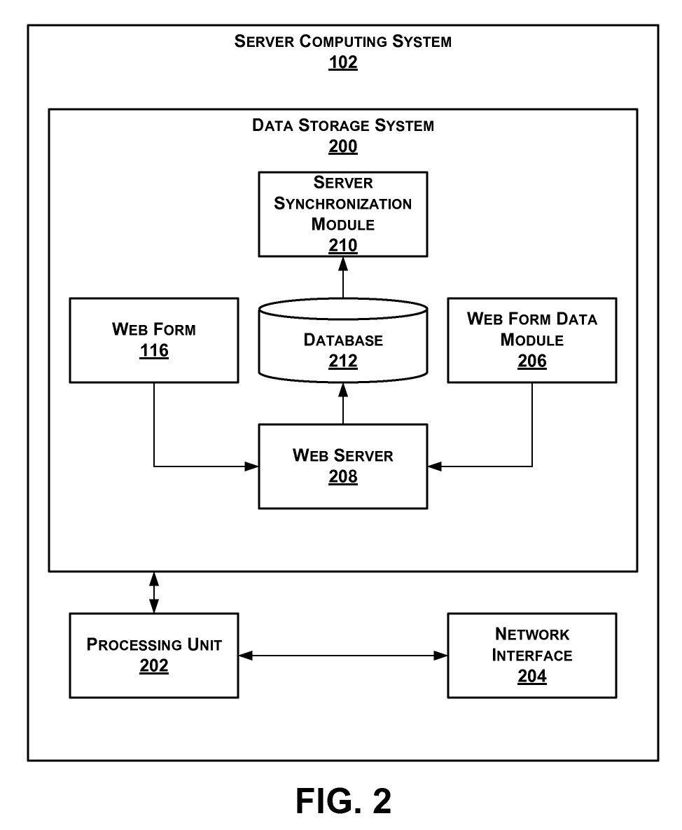

FIG. 2 is a block diagram illustrating example logical components of the server computing system 102. It should be appreciated that FIG. 2 is an example provided for purposes of explanation only. In other instances, the server computing system 102 may contain different logical components. As used in this disclosure, a logical component is a sub-part of a system, the sub-part having a well-defined purpose and functionality.

As illustrated in the example of FIG. 2, the server computing system 102 comprises a data storage system 200, a processing unit 202, and a network interface 204. The network interface 204 enables the server computing system 102 to send data on the network 112 and to receive data from the network 112. As used in this disclosure, a network interface is a set of one or more physical network interface cards. Furthermore, as used in this disclosure, a network interface card is a computer hardware component designed to allow a computer to communicate over an electronic communication network. In some example implementations, the network interface 204 is able to store data received from the network 112 directly into the data storage system 200 and to directly send on the network 112 data stored in the data storage system 200.

As illustrated in the example of FIG. 2, the data storage system 200 stores the web form 116, a web form data module 206, a web server 208, a server synchronization module 210, and a database 212. As mentioned above, the server computing system 102 is a collection of one or more electronic computing devices and the data storage system 200 is a collection of one or more computer-readable data storage media. In implementations where the server computing system 102 comprises a plurality of electronic computing devices and the data storage system 200 comprises a plurality of computer-readable data storage media, one or more of the web form 116, the web form data module 206, the web server 208, the server synchronization module 210, and the database 212 may be stored at different computer-readable data storage media and potentially at computer-readable data storage media in different electronic computing devices. For instance, the web server 208 may be stored at a computer-readable data storage medium at a first server device at a server farm and the database 212 may be stored at a plurality of computer-readable data storage media at a second server device in the server farm.

The database 212 is a data structure that stores blocks of web form data. Each of the blocks of web form data in the database 212 results from individual submissions of one or more web forms. The database 212 may be implemented in a wide variety of ways. For example, the database 212 may be implemented as a relational database, a file structure, a flat file, an object database, or another type of data structure capable of storing blocks of web form data.

In some example implementations, the web server 208 comprises a set of software instructions. This disclosure includes statements that describe the web server 208 as performing various actions. Such statements should be interpreted to mean that the server computing system 102 performs the various actions when the processing unit 202 executes software instructions of the web server 208.

In some example implementations, the web form data module 206 comprises a set of software instructions. This disclosure includes statements that describe the web form data module 206 as performing various actions. Such statements should be interpreted to mean that the server computing system 102 performs the various actions when the processing unit 202 executes software instructions of the web form data module 206. It should be appreciated that in some implementations, the web form data module 206 may be stored on a persistent computer-readable data storage medium as a document comprising high-level or intermediate-level program code. For instance, the web form data module 206 may be stored on a persistent computer-readable data storage medium as a document comprising a Perl script. In such implementations, the program code is interpreted at runtime by other software executing at the server computing system 102 to generate the set of software instructions of the web form data module 206.

In some example implementations, the server synchronization module 210 comprises a set of software instructions. This disclosure includes statements that describe the web server 208 as performing various actions. Such statements should be interpreted to mean that the server computing system 102 performs the various actions when the processing unit 202 executes software instructions of the server synchronization module 210. In some implementations, the server synchronization module 210 may also be stored persistently as a document comprising high-level or intermediate-level program code that is interpreted to generate the set of software instructions of the server synchronization module 210.

The web server 208 receives resource requests from the network 112 via the network interface 204 and responds appropriately to the resource requests. As used in this disclosure, a resource request is a request to perform an action on a resource. Example types of resource requests include get requests that request the web server 208 to return copies of resources to computing systems, delete requests that request the web server 208 to delete resources, post requests that request the web server 208 to submit data to specified resources, and other types of requests to perform actions on resources. In addition, the web server 208 comprises software instructions that, when executed by the processing unit 202, cause the server computing system 102 to respond appropriately to the resource requests. When the web server 208 receives from a computing system a get resource request that specifies the web form 116, the web server 208 sends a copy of the web form 116 to the computing system. When the web server 208 receives a post resource request that specifies the web form data module 206 and that specifies a block of web form data, the web server 208 provides the block of web form data to the web form data module 206. In response to receiving the block of web form data, the web form data module 206 stores the block of web form data into the database 212.

As described in detail below, the server synchronization module 210 sends blocks of web form data to one or more computing systems that host documents comprising form mapping metadata that maps the documents to web forms hosted by the server computing system 102.

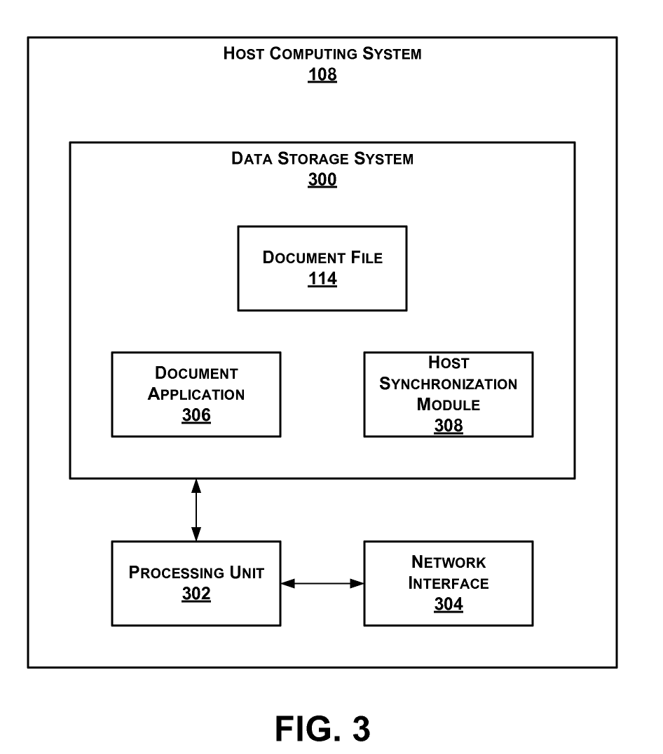

FIG. 3 is a block diagram illustrating example logical components of the host computing system 108. It should be appreciated that FIG. 3 is an example provided for purposes of explanation only. In other instances, the host computing system 108 may contain different logical components.

As illustrated in the example of FIG. 3, the host computing system 108 comprises a data storage medium 300, a processing unit 302, and a network interface 304. The network interface 304 enables the host computing system 108 to send data on the network 112 and to receive data from the network 112. The data storage system 300 stores the document file 114, a document application 306 and a host synchronization module 308.

In some example implementations, the document application 306 comprises a set of software instructions. This disclosure includes statements describing the document application 306 as performing various actions. Such statements should be interpreted to mean that the host computing system 108 performs the various actions when the processing unit 302 executes software instructions of the document application 306. Similarly, the host synchronization module 308 comprises a set of software instructions. This disclosure includes statements describing the host synchronization module 308 as performing various actions. Such statements should be interpreted to mean that the host computing system 108 performs the various actions when the processing unit 302 executes software instructions of the host synchronization module 308.

As described below, the document application 306 enables a user to create, view, and edit a particular type of document. For example, the document application 306 may be a word processor application, a spreadsheet application, or another type of application that enables a user to create, view, and edit a particular type of document. The host synchronization module 308 receives blocks of web form data and automatically updates the document file 114, as appropriate.

In some implementations, the host synchronization module 308 is a component of the document application 306. For instance, the software instructions of the document application 306 may include the software instructions of the host synchronization module 308.

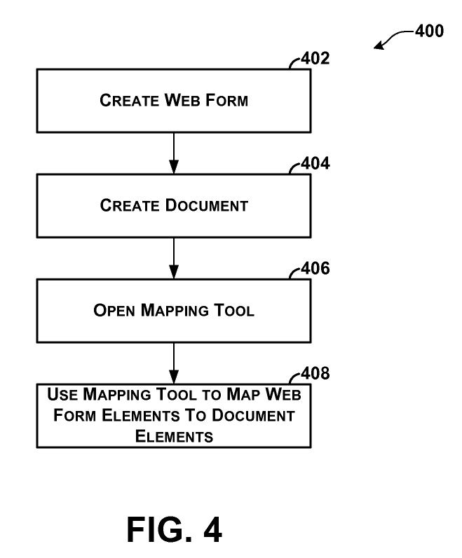

FIG. 4 is a flowchart illustrating an example operation 400 performed by the administrator 110 to configure a document to be automatically updated based on data from a web form. It should be appreciated that the operation 400 is an example provided for purposes of explanation only. In other implementations, operations to configure the document to be automatically updated based on data from a web form may involve more or fewer steps, or may involve the steps of the operation 400 in a different order. Furthermore, the operation 400 is explained with reference to FIGS. 1-3. It should be appreciated that other operations to configure a document to be automatically updated based on data from a web form may be used in different systems and in computing systems having logical components other than those illustrated in the examples of FIGS. 1-3.

As illustrated in the example of FIG. 4, the operation 400 begins when the administrator 110 creates the web form 116 (402). The administrator 110 may create the web form 116 in a variety of ways. For example, the administrator 110 can use a text editor to create a file containing HTML code representing the web form 116. As used in this disclosure, a text editor is a software application that enables a user to produce a text document. In another example, the administrator 110 can use a “What you see is what you get” (WYSIWYG) Hypertext Markup Language (HTML) editor to create a file containing HTML code representing the web form 116. Example WYSIWYG HTML editors include Microsoft SharePoint Designer, Microsoft Office Live Small Business, Adobe Dreamweaver, Apple iWeb, and so on.

After creating the web form 116, the administrator 110 creates the document file 114 (404). The administrator 110 may create different types of document files using different software applications. For instance, the administrator 110 may create a word processor document using a word processor application. When the administrator 110 creates the document file 114, the host computing system 108 stores the document file 114 at data storage system 300.

After creating the document file 114, the administrator 110 opens a mapping tool provided by the host computing system 108 (406). The mapping tool is a user interface that enables the administrator 110 to map web form elements in a web form to document elements in the document. In a first example implementation, the administrator 110 may open the mapping tool by clicking on a control in a user interface provided by the document application 306. In a second example implementation, the administrator 110 may open the mapping tool by entering a keyboard command while a document application user interface presented by the document application 306 is in focus. In a third example implementation, the server computing system 102 provides the mapping tool. In this third example implementation, a user of the server computing system 102 opens and uses the mapping tool to configure a document to be automatically updated based on data from a web form. In a fourth example implementation, the administrator 110 opens the mapping tool by selecting a command in a user interface of a WYSIWYG HTML editor application while the administrator 110 is editing the web form 110.

Once the administrator 110 has opened the mapping tool, the administrator 110 uses the mapping tool to map web form elements in the web form 116 to document elements in the document (408). In a first example implementation, the mapping tool first enables the administrator 110 to select the web form 116 from a list of available web forms. After selecting the web form 116 from the list of available web forms, the mapping tool presents a list of web form elements in the web form 116 and a list of document elements in the document file 114. The administrator 110 may then select a web form element in the list of web form elements and a document element in the list of document elements, thereby mapping the selected web form element to the selected document element. In some instances, the mapping tool presents a list of available transformation or allows the administrator 110 to create a new transformation. In such instances, the administrator 110 either selects one of the available transformations for the selected document element or creates a new transformation for the selected document element.

In a second example implementation, the administrator 110 opens the mapping tool from a user interface of a WYSIWYG HTML editor application while the administrator 110 is editing the web form 110. In this second example implementation, the mapping tool displays a list of available document files and document file templates. When the administrator 110 selects a document file or a document file template from the list of available document files and document file templates, the mapping tool presents a list of documents elements in the selected document file or document file template and a list of web form elements in the web form 116. The administrator 110 may then select a web form element in the list of web form elements and a document element in the list of document elements, thereby mapping the selected web form element to the selected document element. As used in this disclosure, a document file template is a document file already containing some content with remaining content to be filled out by a user.

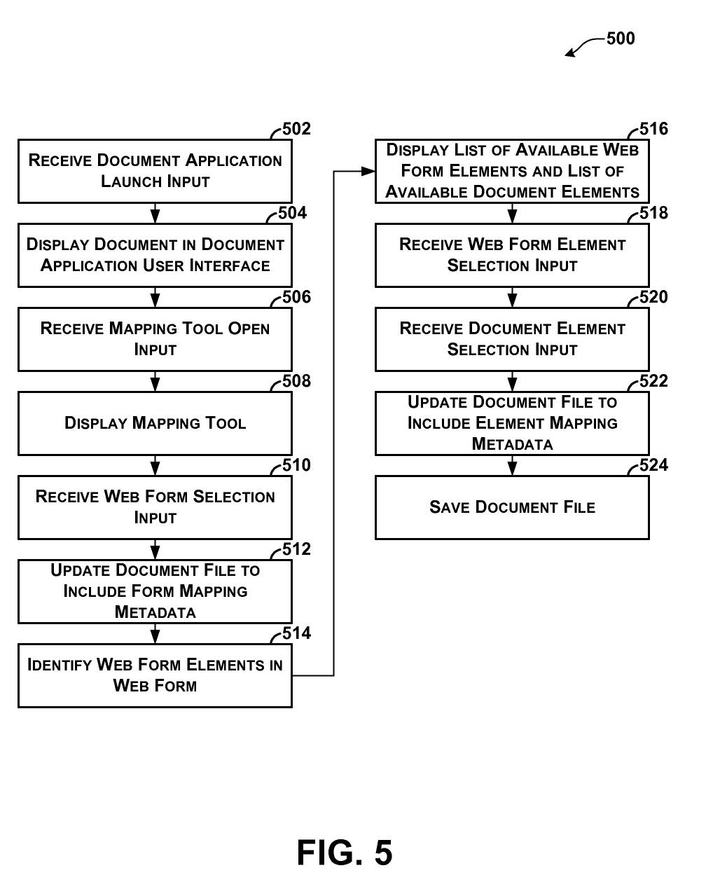

FIG. 5 is a flowchart illustrating an example operation 500 performed by the host computing system 108 to configure a document to be automatically updated based on data from a web form. It should be appreciated that the operation 500 is an example provided for purposes of explanation only. In other implementations, operations to configure a document to be automatically updated based on data from a web form may involve more or fewer steps, or may involve the steps of the operation 500 in a different order. Furthermore, the operation 500 is explained with reference to FIGS. 1-3. It should be appreciated that other operations to configure a document to be automatically updated based on data from a web form may be used in different systems and in computing systems having logical components other than those illustrated in the examples of FIGS. 1-3.

As illustrated in the example of FIG. 5, the operation 500 begins when the host computing system 108 receives document application launch input from the administrator 110 (502). The document application launch input indicates to the host computing system 108 that the administrator 110 wants the host computing system 108 to launch the document application 306. The administrator 110 may provide the document application launch input to the host computing system 108 in a variety of ways. In a first example, the administrator 110 may use a mouse to double-click on an icon associated with the document application 306. In a second example, the administrator 110 may enter a command into a command line user interface. In a third example, the administrator 110 may double click on an icon representing a document file of a type associated with the document application 306.

In response to receiving the document application launch input, the host computing system 108 automatically displays a document application user interface (504). Initially or after the user provides additional input to the host computing system 108, the document application 306 opens a document and causes the document application user interface to contain at least part of the document. For purposes of explanation, this disclosure assumes that the document application user interface contains all of part of the document represented by the document file 114.

Subsequently, the host computing system 108 receives mapping tool open input (506). The mapping tool open input indicates to the host computing system 108 that the administrator 110 wants the host computing system 108 to display the mapping tool. The administrator 110 may provide the mapping tool open input to the host computing system 108 in a variety of ways. For example, the document application user interface may include a mapping tool icon associated with the mapping tool. In this example, the administrator 110 may cause the host computing system 108 to receive the mapping tool open input when by clicking on the mapping tool icon.

In response to receiving the mapping tool open input, the host computing system 108 automatically displays the mapping tool (508). As mentioned above, the mapping tool is a user interface that enables the administrator 110 to map web form elements of a web form to document elements of the document. In one example implementation, the mapping tool enables the administrator 110 to select a web form. The mapping tool may enable the administrator 110 to select a web form in a variety of ways. For instance, the mapping tool may comprise a list of available web forms. In another instance, the mapping tool may comprise a file browse control that enables the administrator 110 to browse for a web form.

The mapping tool may be implemented in a variety of ways. In one example implementation, the mapping tool is implemented as a popup window displayed in front of the document application user interface. In another example implementation, the mapping tool is implemented as a sidebar or task pane within the document application user interface.

After displaying the mapping tool, the host computing system 108 receives web form selection input via the mapping tool (510). The web form selection input indicates to the host computing system 108 that the administrator 110 wants to select a particular web form. For instance, the web form selection input may indicate to the host computing system 108 that the administrator 110 wants to select the web form 116. For purposes of explanation, this disclosure assumes that the administrator 110 selected the web form 116.

In response to receiving the web form selection input, the host computing system 108 automatically updates the document file 114 to include form mapping metadata (512). The form mapping metadata is metadata within the document file 114. The form mapping metadata specifies the web form 116.

After updating the document file 114 to include the form mapping metadata, the host computing system 108 identifies web form elements in the web form 116 (514). In one example implementation, the host computing system 108 identifies the web form elements in the web form 116 by retrieving the web form 116 from the server computing system 102 and parsing the web form 116. In another example implementation, the host computing system 108 identifies the web form elements in the web form 116 by sending a request to the server computing system 102 to send back a list of the web form elements in the web form 116.

Once the host computing system 108 has identified the web form elements in the web form 116, the host computing system 108 automatically causes the mapping tool to display a list of the web form elements and a list of document elements in the document file 114 (516). In this way, the administrator 110 is able to see the web form elements and the document elements.

Next, the host computing system 108 receives web form element selection input via the mapping tool (518). The web form element selection input indicates to the host computing system 108 that the administrator 110 wants to map a web form element in the list of available web form elements to some document element in the list of document elements. This disclosure refers to the web form element indicated by the web form element selection input as the selected web form element. The host computing system 108 may receive the web form element selection input in a variety of ways. For instance, the host computing system 108 may receive the web form element selection input when the administrator 110 clicks on a web form element in the list of web form elements in the mapping tool.

The host computing system 108 also receives document element selection input via the mapping tool (520). The document element selection input indicates to the host computing system 108 that the administrator 110 wants to map a document element in the list of document elements to the selected web form element. This disclosure refers to the document element indicated by the document element selection input as the selected document element. The host computing system 108 may receive the document element selection input in a variety of ways. For instance, the host computing system 108 may receive the document element selection input when the administrator 110 clicks on a document element in the list of available document elements in the mapping tool.

After receiving the web form element selection input and the document element selection input, the host computing system 108 updates the document file to include element mapping metadata (522). The element mapping metadata maps the selected web form element to the selected document element. It should be appreciated that in other example implementations, the host computing system 108 may be configured to automatically identify corresponding document elements in the document file 114 and web form elements in the web form 116. In such example implementations, the host computing system 108 may be configured to automatically update the document file 114 to include element mapping metadata that maps the document elements to the corresponding web form elements.

Subsequently, the host computing system 108 saves the document file 114 (524). As used in this disclosure, saving a document file entails storing the document file to one or more persistent computer-readable data storage media.

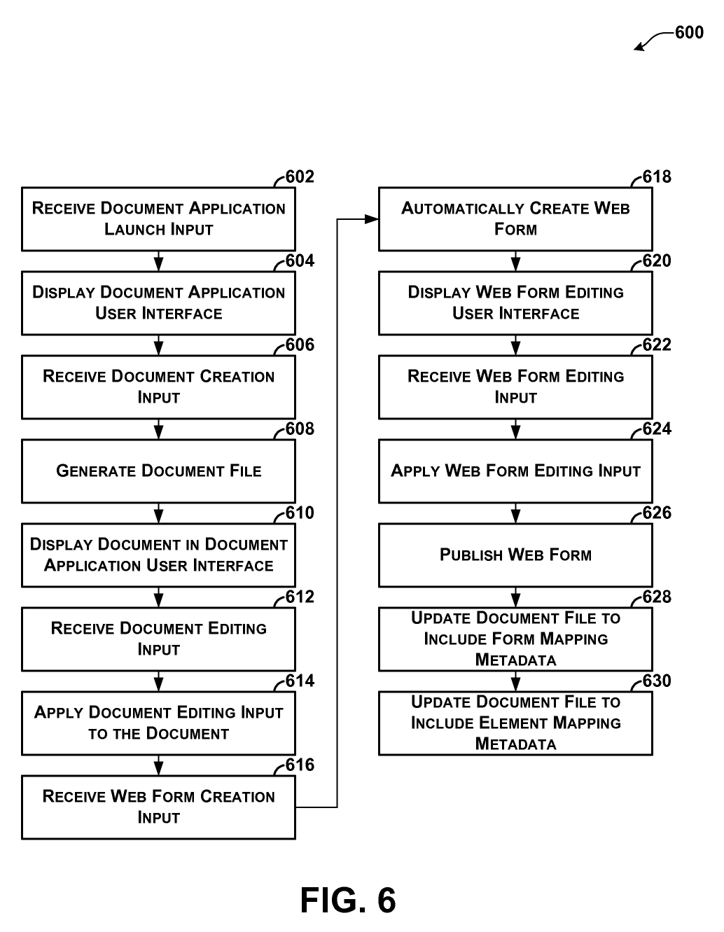

FIG. 6 is a flowchart illustrating an example alternate operation 600 performed by the host computing system 108 to configure a document to be automatically updated based on data from a web form. It should be appreciated that the operation 600 is an example provided for purposes of explanation only. In other implementations, operations to configure a document to be automatically updated based on data from a web form may involve more or fewer steps, or may involve the steps of the operation 600 in a different order. Furthermore, the operation 600 is explained with reference to FIGS. 1-3. It should be appreciated that other operations to configure a document to be automatically updated based on data from a web form may be used in different systems and in computing systems having logical components other than those illustrated in the examples of FIGS. 1-3.

As illustrated in the example of FIG. 6, the operation 600 begins when the host computing system 108 receives document application launch input from the administrator 110 (602). The document application launch input indicates to the host computing system 108 that the administrator 110 wants the host computing system 108 to launch the document application 306.

In response to receiving the document application launch input, the host computing system 108 automatically displays a document application user interface (604). In different implementations, the document application user interface is implemented in a variety of different ways. In some implementations, the document application user interface is a graphical user interface comprising a set of controls. As used in this disclosure, a control is a portion of a graphical user interface that, when selected by a user, causes a computing system to perform a command. Example types of controls include icons, drop boxes, check boxes, and other portions of a graphical user interface that, when selected by a user, cause a computing system to perform a command.

After the host computing system 108 displays the document application user interface, the host computing system 108 receives document creation input from the administrator 110 (606). The document creation input indicates that the administrator 110 wants to create a new document. The host computing system 108 may receive the document creation input in a variety of ways. For instance, the host computing system 108 may receive the document creation input when the administrator 110 clicks on an icon associated with the creation of a new document.

In response to receiving the document creation input, the host computing system 108 generates a new document file (608). For purposes of explanation, this disclosure assumes that the document file 114 is the new document file. After the host computing system 108 generates the new document file, the host computing system 108 displays at least part of the document represented by the document file 114 in the document application user interface (610).

After the host computing system 108 generates the document file 114, the host computing system 108 receives document editing input (612). The document editing input indicates edits that the administrator 110 wants to make to the document. For instance, the document editing input may indicate that the administrator 110 wants to add text to the document. The document editing input may include element creation input. The element creation input indicates that the administrator 110 wants to add a new document element to the document.

In response to receiving the document editing input, the host computing system 108 automatically applies the document editing input to the document (614). Applying the document editing input to the document entails automatically updating the document file 114 such that the document reflects the edits indicated by the document editing input. For instance, where the document editing input is element creation input, the host computing system 108 may update the document file 114 to include a new document element.

Subsequently, the host computing system 108 receives web form creation input (616). The web form creation input indicates to the host computing system 108 that the administrator 110 wants to create a new web form based on the document. The host computing system 108 may receive the web form creation input in a variety of ways. For example, the host computing system 108 may receive the web form creation input when the administrator 110 clicks on a control in the document application user interface.

In response to receiving the web form creation input, the host computing system 108 automatically creates a new web form (618). The new web form comprises a web form element for each document element in the document. For example, if the document comprises a text box element, the new web form comprises a text box web form element that enables a user to add text to the text box element in the document.

In addition, the host computing system 108 automatically displays a web form editing user interface (620). The web form editing user interface enables the administrator 110 to edit the new web form. For example, the web form editing user interface enables the administrator 110 to add labels to the web form elements in the new web form, apply colors and themes to the new web form, and otherwise edit the new web form.

After the host computing system 108 displays the web form editing user interface, the host computing system 108 receives web form editing input (622). The web form editing input indicates edits that the administrator 110 wants to make to the new web form. In response to receiving the web form editing input, the host computing system 108 automatically applies the web form editing input to the new web form (624).

Subsequently, the host computing system 108 publishes the new web form (626). Publishing the new web form entails transmitting the new web form to a server computing system (e.g., the server computing system 102) that hosts the new web form. When the server computing system hosts the new web form, the new web form is accessible to one or more users via an electronic communications network.

After the host computing system 108 publishes the new web form, the host computing system 108 automatically updates the document file 114 to include form mapping metadata (628). The form mapping metadata specifies the new web form. For instance, the form mapping metadata may specify a Uniform Resource Locator (URL) of the new web form as hosted by the server computing system. The host computing system 108 also automatically updates the document file 114 to include element mapping metadata (630). The element mapping metadata maps the document elements in the document to the web form elements in the new web form.

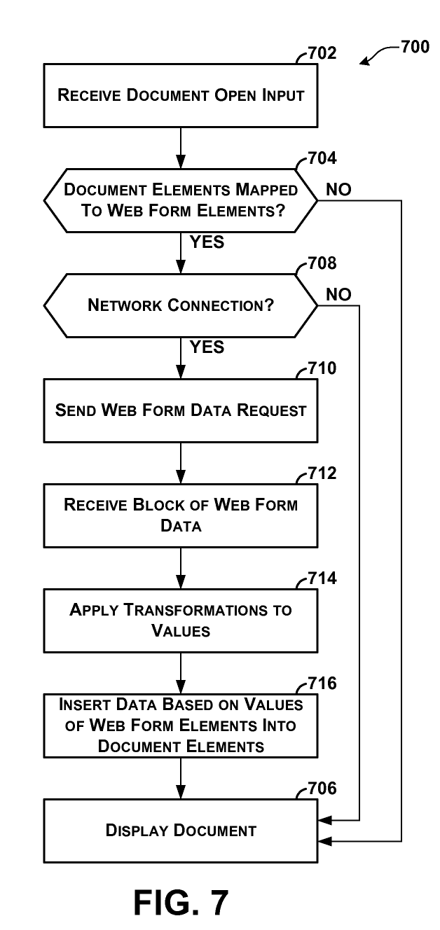

FIG. 7 is a flowchart illustrating an example operation 700 performed by the host computing system 108 when the host computing system 108 receives document open request. It should be appreciated that the operation 700 is an example provided for purposes of explanation only. In other implementations, operations performed by the host computing system 108 when the host computing system 108 receives document open request may involve more or fewer steps, or may involve the steps of the operation 700 in a different order. Furthermore, the operation 700 is explained with reference to FIGS. 1-3. It should be appreciated that other operations performed by the host computing system 108 when the host computing system 108 receives document open request may be used in different systems and in computing systems having logical components other than those illustrated in the examples of FIGS. 1-3.

As illustrated in the example of FIG. 7, the operation 700 begins when the host computing system 108 receives document open request from the administrator 110 (702). The document open request indicates that the administrator 110 wants to open a document represented by a particular document file. For purposes of explanation, this disclosure assumes that the document open request indicates that the administrator 110 wants to open the document represented by the document file 114. The host computing system 108 may receive the document open request in a variety of ways. For example, the host computing system 108 may receive the document open request when the administrator 110 clicks on an icon representing the document file 114. In another example, the host computing system 108 may receive the document open request when the administrator 110 opens a document open dialog box in a document application user interface provided by the document application 306.

After the host computing system 108 receives the document open request, the host synchronization module 308 determines whether there are any document elements in the document mapped to web form elements (704). The host synchronization module 308 determines whether there are any document elements in the document that are mapped to web form elements by determining whether the document file 114 includes element mapping metadata that maps document elements in the document to web form elements in a web form. Alternatively, the host synchronization module 308 may determine whether there are any document elements in the document that are mapped to web form elements by determining whether the document file 114 includes form mapping metadata. If the host synchronization module 308 determines that the document does not include any document elements mapped to web form elements (“NO” of 704), the host computing system 108 automatically displays the document in a document application user interface provided by the document application 306 (706).

On the other hand, if the host synchronization module 308 determines that the document includes one or more document elements mapped to web form elements in a web form (“YES” of 704), the host synchronization module 308 determines whether there is a network connection between the host computing system 108 and a server computing system that hosts the web form (708). For purposes of explanation, this disclosure assumes that the web form is the web form 116 and the server computing system that hosts the web form is the server computing system 102. As used in this disclosure, there is a network connection between a first computing system and a second computing system when the first computing system and the second computing system are able to communicate with each other via an electronic communication network. If there is no network connection between the host computing system 108 and the server computing system 102 (“NO” of 708), the host computing system 108 automatically displays the document in the document application user interface provided by the document application 306 (706).

If the host synchronization module 308 determines that there is a network connection between the host computing system 108 and the server computing system 102 (“YES” of 708), the host synchronization module 308 sends a web form data request to the server computing system 102 (710). The web form data request requests the server computing system 102 to send to the host computing system 108 one or more blocks of web form data associated with the web form 116.

In response to the web form data request, the host computing system 108 receives one or more blocks of web form data from the server computing system 102 (712). Each of the blocks of web form data includes values assigned to web form elements in the web form 116.

In response to receiving a block of web form data, the host synchronization module 308 applies one or more transformations to the values assigned to the web form elements, thereby generating data based on the values (714). As mentioned above, a transformation is a logical mapping from a first piece of data to a second piece of data. The host synchronization module 308 may apply a wide variety of transformations to the values assigned to the web form elements. For example, a first transformation may map the string “Minnesota” to the string “MN.” In a second example, a document element in the document file 114 does not initially contain any data. Furthermore, in this second example, the host synchronization module 308 applies a second transformation to cause the document file 114 to include a given set of data when a first value is assigned to a given web form element and not to include the given set of data when a second value is assigned to the given web form element. In this way, the document file 114 may include or exclude entire sections of text based on the values assigned to web form elements. In a third example, a third transformation maps values assigned to a plurality of web form elements to a given set of data. For instance, in this third example, if the value “Mary” is assigned to a first web form element and the value “Johnson” is assigned to a second web form element, applying the third transformation may generate the string “Mrs. M. Johnson.” In some implementations, the element mapping metadata in the document file 114 specifies transformations to apply for each document element in the document file 114.

After applying the transformations to the values assigned to the web form elements, the host synchronization module 308 automatically inserts the data based on the values assigned to the web form elements into the document elements of the document file 114 when the document file 114 comprises element mapping metadata that maps the document elements to the web form elements (716). Next, the host computing system 108 automatically displays the document in the document application user interface provided by the document application (706).

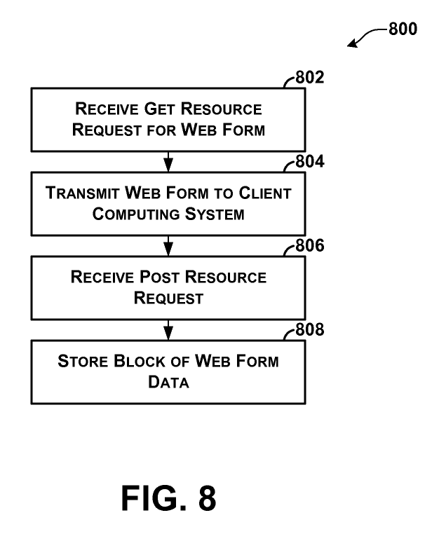

FIG. 8 is a flowchart illustrating an example operation 800 performed by the server computing system 102 to host the web form 116. It should be appreciated that the operation 800 is an example provided for purposes of explanation only. In other implementations, operations performed by the server computing system 102 to host the web form 116 may involve more or fewer steps, or may involve the steps of the operation 800 in a different order. Furthermore, the operation 800 is explained with reference to FIGS. 1 and 2. It should be appreciated that other operations to host the web form 116 may be used in different systems and in computing systems having logical components other than those illustrated in the examples of FIGS. 1 and 2.

As illustrated in the example of FIG. 8, the operation 800 begins when the web server 208 receives from the client computing system 104 a get resource request for the web form 116 (802). The get resource request requests the server computing system 102 to send a copy of the web form 116 to the client computing system 104. In response to receiving the get resource request for the web form 116, the web server 208 automatically transmits a copy of the web form 116 to the client computing system 104 (804).

Subsequently, the web server 208 receives a post resource request from the client computing system 104 (806). The post resource request specifies the web form data module 206. In addition, the post resource request specifies a block of web form data. The block of web form data comprises values assigned to web form elements in the web form 116. When the web server 208 receives the post resource request, the web form data module 206 stores the block of web form data in the database 212 (808).

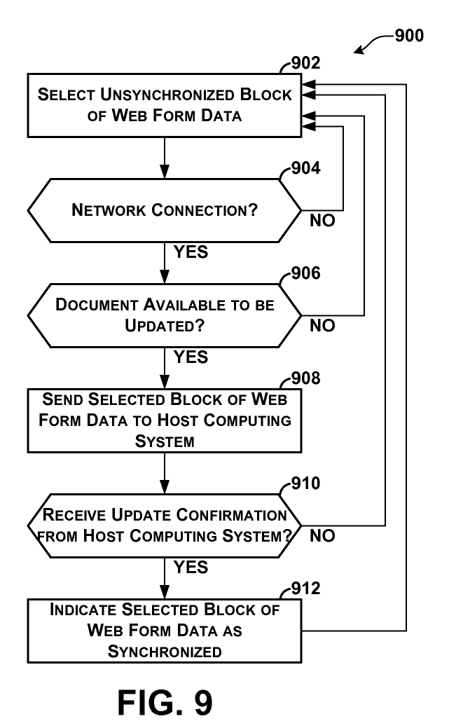

FIG. 9 is a flowchart illustrating an example operation 900 performed by the server computing system 102 to synchronize blocks of web form data with documents. It should be appreciated that the operation 900 is an example provided for purposes of explanation only. In other implementations, operations performed by the server computing system 102 to synchronize blocks of web form data may involve more or fewer steps, or may involve the steps of the operation 900 in a different order. Furthermore, the operation 900 is explained with reference to FIGS. 1 and 2. It should be appreciated that other operations to synchronize blocks of web form data with documents may be used in different systems and in computing systems having logical components other than those illustrated in the examples of FIGS. 1 and 2.

As discussed above, the database 212 may store multiple blocks of web form data. Each block of web form data in the database 212 may include a synchronization flag. The synchronization flag of a block of web form data indicates whether the block of web form data has been successfully synchronized with a document. As used in this disclosure, a block of web form data has been synchronized with a document when the document comprises metadata that maps a document element in the document with a web form element in the web form and when the document file has been updated such that the document element specifies a value in the block of web form data assigned to the web form element. The database 212 may also store form mapping data entries. Each form mapping data entry maps a different web form hosted by the server computing system 102 to document files that include form mapping metadata that map the document file to the web form.

As illustrated in the example of FIG. 9, the operation 900 starts when the server synchronization module 210 automatically selects an unsynchronized block of web form data in the database 212 (902). In different implementations, the server synchronization module 210 may select the unsynchronized block of web form data in different ways. For example, the server synchronization module 210 may select unsynchronized blocks of web form data at random. In another example, the server synchronization module 210 may select unsynchronized blocks of web form data that have not been selected in a given period of time (e.g., 15 minutes).

After the server synchronization module 210 has selected an unsynchronized block of web form data, the server synchronization module 210 automatically determines whether there is a network connection between the server computing system 102 and a computing system that hosts a document associated with the selected block of web form data (904). As used in this disclosure, a document is associated with a block of web form data comprising a value assigned to a web form element in a web form when the document comprises element mapping metadata that maps a document element in the document to the web form element. Furthermore, as used in this disclosure, a computing system is associated with a block of web form data when the computing system hosts a document associated with the block of web form data. If there is no network connection between the server computing system 102 and the computing system associated with the block of web form data (“NO” of 904), the server synchronization module 210 automatically loops back and selects another unsynchronized block of web form data in the database 212 (902).

On the other hand, if the server synchronization module 210 determines that there is a network connection between the server computing system 102 and the computing system associated with the selected block of web form data (“YES” of 904), the server synchronization module 210 automatically determines whether the document associated with the selected block of web form data is available to be updated (906). As used in this disclosure, a document is available to be updated when the document can be updated at the current time. A document may not be available to be updated at a given time for a variety of reasons. For example, a document may not be available to be updated when a user is currently editing the document. If the document associated with the selected block of web form data is not available to be updated (“NO” of 906), the server synchronization module 210 automatically loops back and selects another unsynchronized block of web form data in the database 212 (902).

However, if the document associated with the selected block of web form data is available to be updated (“YES” of 906), the server synchronization module 210 automatically sends the selected block of web form data to the computing system associated with the selected block of web form data (908). In different implementations, the server synchronization module 210 may send the selected block of web form data in a variety of ways. For example, when a computing system that hosts a document starts up, the computing system may register a callback with the server computing system 102. In this example, the server synchronization module 210 uses the callback to send the selected block of web form data to the computing system.

After sending the selected block of web form data to the computing system associated with the selected block of web form data, the server synchronization module 210 automatically determines whether the server synchronization module 210 received an update confirmation from the computing system associated with the selected block of web form data (910). The update confirmation indicates that the computing system successfully updated the document associated with the selected block of web form data based on the selected block of web form data. If the server synchronization module 210 does not receive the update confirmation (“NO” of 910), the server synchronization module 210 automatically loops back and selects another unsynchronized block of web form data in the database 212 (902).

If the server synchronization module 210 received the update confirmation (“YES” of 910), the server synchronization module 210 automatically indicates that the selected block of web form data is synchronized (912). In some example implementations, the server synchronization module 210 indicates that the selected block of web form data is synchronized by updating the synchronization flag associated with the selected block of web form data. After indicating that the selected block of web form data is synchronized, the server synchronization module 210 loops back and automatically selects another unsynchronized block of web form data (902).

FIG. 10 is a block diagram illustrating example physical components of an electronic computing device 1000. As illustrated in the example of FIG. 10, the electronic computing device 1000 comprises a memory unit 1002. The memory unit 1002 is a computer-readable data storage medium capable of storing data and/or instructions. The memory unit 1002 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, the electronic computing device 1000 comprises a processing unit 1004. As mentioned above, a processing unit is a set of one or more physical electronic integrated circuits that are capable of executing instructions. In a first example, the processing unit 1004 may execute software instructions that cause the electronic computing device 1000 to provide specific functionality. In this first example, the processing unit 1004 may be implemented as one or more processing cores and/or as one or more separate microprocessors. For instance, in this first example, the processing unit 1004 may be implemented as one or more Intel Core 2 microprocessors. The processing unit 1004 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, the processing unit 1004 may be implemented as an ASIC that provides specific functionality. In a third example, the processing unit 1004 may provide specific functionality by using an ASIC and by executing software instructions.

The electronic computing device 1000 also comprises a video interface 1006. The video interface 1006 enables the electronic computing device 1000 to output video information to a display device 1008. The display device 1008 may be a variety of different types of display devices. For instance, the display device 1008 may be a cathode-ray tube display, an LCD display panel, a plasma screen display panel, a touch-sensitive display panel, a LED array, or another type of display device.

In addition, the electronic computing device 1000 includes a non-volatile storage device 1010. The non-volatile storage device 1010 is a computer-readable data storage medium that is capable of storing data and/or instructions. The non-volatile storage device 1010 may be a variety of different types of non-volatile storage devices. For example, the non-volatile storage device 1010 may be one or more hard disk drives, magnetic tape drives, CD-ROM drives, DVD-ROM drives, Blu-Ray disc drives, or other types of non-volatile storage devices.

The electronic computing device 1000 also includes an external component interface 1012 that enables the electronic computing device 1000 to communicate with external components. As illustrated in the example of FIG. 10, the external component interface 1012 enables the electronic computing device 1000 to communicate with an input device 1014 and an external storage device 1016. In one implementation of the electronic computing device 1000, the external component interface 1012 is a Universal Serial Bus (USB) interface. In other implementations of the electronic computing device 1000, the electronic computing device 1000 may include another type of interface that enables the electronic computing device 1000 to communicate with input devices and/or output devices. For instance, the electronic computing device 1000 may include a PS/2 interface. The input device 1014 may be a variety of different types of devices including, but not limited to, keyboards, mice, trackballs, stylus input devices, touch pads, touch-sensitive display screens, or other types of input devices. The external storage device 1016 may be a variety of different types of computer-readable data storage media including magnetic tape, flash memory modules, magnetic disk drives, optical disc drives, and other computer-readable data storage media.

In addition, the electronic computing device 1000 includes a network interface card 1018 that enables the electronic computing device 1000 to send data to and receive data from an electronic communication network. The network interface card 1018 may be a variety of different types of network interface. For example, the network interface card 1018 may be an Ethernet interface, a token-ring network interface, a fiber optic network interface, a wireless network interface (e.g., WiFi, WiMax, etc.), or another type of network interface.

The electronic computing device 1000 also includes a communications medium 1020. The communications medium 1020 facilitates communication among the various components of the electronic computing device 1000. The communications medium 1020 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

The electronic computing device 1000 includes several computer-readable data storage media (i.e., the memory unit 1002, the non-volatile storage device 1010, and the external storage device 1016). Together, these computer-readable storage media may constitute a single data storage system. As discussed above, a data storage system is a set of one or more computer-readable data storage mediums. This data storage system may store instructions executable by the processing unit 1004. Activities described in the above description may result from the execution of the instructions stored on this data storage system. Thus, when this description says that a particular logical module performs a particular activity, such a statement may be interpreted to mean that instructions of the logical module, when executed by the processing unit 1004, cause the electronic computing device 1000 to perform the activity. In other words, when this description says that a particular logical module performs a particular activity, a reader may interpret such a statement to mean that the instructions configure the electronic computing device 1000 such that the electronic computing device 1000 performs the particular activity.

The techniques of this disclosure may be realized in many ways. For example, the techniques of this disclosure may be realized as a method for automatically updating documents based on data from web forms. The method comprises storing, at a data storage system accessible to a computing system, a document file comprising data that represents a document. The document is a discrete set of human-readable content. The document comprises a document element. The document element is a logical sub-part of the document. The method also comprises after storing the document file, receiving, at the computing system, a block of web form data. The block of web form data comprises a value submitted to a server computing system via a web form. The web form comprises a web form element. The value is assigned to the web form element. In addition, the method comprises in response to receiving the block of web form data, automatically updating, by the computing system, the document file such that the document element specifies the value only when the document file comprises element mapping metadata that maps the document element to the web form element.

In another example, the techniques of this disclosure may be realized as a server computing system comprising a processing unit and a data storage system. The data storage system storing software instructions that, when executed by the processing unit, cause the server computing system to receive a block of web form data from a client computing system. The block of web form data comprises a value submitted to the server computing system via a web form. The web form comprises a web form element. The value is assigned to the web form element. The software instructions also cause the server computing system to automatically send the block of web form data to a host computing system. The host computing system hosts a document file. The document file comprises data that represents a document. The document is a discrete set of human-readable content. The document comprises a document element. The document element is a logical sub-part of the document. The document file comprises element mapping metadata that maps the document element to the web form element. The host computing system configured to respond to receiving the block of web form data by automatically updating the document file such that the document element specifies the value.

In another example, the techniques of this disclosure may be realized as a computer-readable data storage medium comprising software instructions that, when executed by a processing unit of a computing system, cause the computing system to receive, at the computing system, document creation input from a user. The document creation input indicates that the user wants to create a word processor document. In response to receiving the document creation input, the software instructions cause the computing system to generate, at the computing system, a document file comprising data that represents the word processor document. The word processor document is a document comprising human-readable content having a specific format that defines how the human-readable content is laid out when the word processor document is physically printed. After generating the document file, the software instructions cause the computing system to receive, at the computing system, element creation input from the user. The element creation input indicates that the user wants to add a document element to the word processor document. The document element is a text box within the word processor document. The document element is visibly differentiated from other parts of the word processor document. In response to receiving the element creation input, the software instructions cause the computing system to update, by the computing system, the document file such that the word processor document includes the document element. After updating the document file to include the document element, the software instructions cause the computing system to receive, at the computing system, mapping tool open input, the mapping tool open input indicating that the user wants the computing system to display a mapping tool. The mapping tool is a user interface that enables the user to map web form elements to document elements in the word processor document. In response to receiving the mapping tool open input, the software instructions cause the computing system to automatically cause, by the computing system, a display device to display the mapping tool. In addition, the software instructions cause the computing system to receive, at the computing system, web form selection input via the mapping tool. The web form selection input specifies a web form. In response to receiving the web form selection input, the software instructions cause the computing system to automatically update, at the computing system, the document file to contain form mapping metadata. The form mapping metadata specifies the web form. In response to receiving the web form selection input, the software instructions cause the computing system to automatically identify, by the computing system, web form elements in the web form. In response to receiving the web form selection input, the software instructions cause the computing system to automatically cause, by the computing system, the display device to display a list of the web form elements in the web form and a list of document elements in the word processor document. After causing the display device to display the list of web form elements in the web form and the list of document elements in the word processor document, the software instructions cause the computing system to receive, at the computing system, web form element selection input via the mapping tool. The element selection input indicates that the user has selected a web form element from the list of web form elements. After causing the display device to display the list of web form elements in the web form and the list of document elements in the word processor document, the software instructions cause the computing system to receive, at the computing system, document element selection input via the mapping tool. The document element selection input indicates that the user has selected the document element from the list of document elements in the word processor document. In response to receiving the element selection input, the software instructions cause the computing system to update, at the computing system, the document file to contain element mapping metadata. The element mapping metadata maps the document element to the web form element. The software instructions also cause the computing system to save, by the computing system, the document file at a data storage system accessible to the computing system. Furthermore, the software instructions cause the computing system to receive, at the computing system, a document open request from the user. The document open request indicating that the user wants to open the word processor document. In response to receiving the document open request, the software instructions cause the computing system to automatically determine, at the computing system, whether the document file comprises the element mapping metadata. In response to determining that the document file comprises the element mapping metadata, the software instructions cause the computing system to automatically send, by the computing system, a web form data request to a server computing system via an electronic communications network. Furthermore, the software instructions cause the computing system to receive, at the computing system, a block of web form data from the server computing system. The computing system receives the block of web form data in response to the web form data request. The block of web form data comprises a value submitted to the server computing system via the web form. The value is assigned to the web form element. In addition, the software instructions cause the computing system to determine, at the computing system, whether the element mapping metadata indicates that the value is to be appended to data specified by the document element, whether the value is to replace the data specified by the document element, or whether the computing system is to create a new copy of the document file in which the value replaces the data specified by the document element. In response to receiving the block of web form data, the software instructions cause the computing system to automatically replace, by the computing system, the data specified by the document element with the value when the element mapping metadata indicates that the value is to replace the data specified by the document element. In addition, the software instructions cause the computing system to automatically append, by the computing system, the value to the data specified by the document element when the element mapping metadata indicates that the value is to be appended to the data specified by the document element. Furthermore, the software instructions cause the computing system to automatically create, by the computing system, the new copy of the document file when the element mapping metadata indicates that the computing system is to create the new copy of the document file in which the value replaces the data specified by the document element.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for automatically updating documents based on data from web forms, the method comprising:
storing, at a data storage system accessible to a computing system, a document file comprising data that represents a document, the document being a discrete set of human-readable content, the document comprising a document element, the document element being a logical sub-part of the document;
receiving, at the computing system, a block of web form data, the block of web form data comprising a value submitted to a server computing system via a web form, the web form comprising a web form element, the value assigned to the web form element; and
in response to receiving the block of web form data, automatically insert, by the computing system, data based on the value into the document element of the document file when the document file comprises element mapping metadata that maps the document element to the web form element.

2. The method of claim 1,
wherein the document is a word processor document; and
wherein the document element one of: a text box within the word processor document.

3. The method of claim 1, wherein storing the document file comprises storing, by the computing system, the document file at the data storage system in response to receiving the block of web form data.

4. The method of claim 1,
wherein the document is a spreadsheet document; and
wherein the document element is one of:
a row within the spreadsheet document,
a column within the spreadsheet document,
a range of rows within the spreadsheet document, or
a range of columns within the spreadsheet document.

5. The method of claim 1, further comprising:
in response to receiving the block of web form data and prior to automatically inserting the data based in the value into the document element, automatically applying, by the computing system, a transformation to the value, thereby generating the data based on the value.

6. The method of claim 1, further comprising:
before receiving the block of web form data:
receiving, at the computing system, a document open request from a user, the document open request indicating that the user wants to open the document file;
in response to receiving the document open request, automatically determining, by the computing system, whether the document file comprises the element mapping metadata; and
in response to determining that the document file comprises the element mapping metadata, automatically sending, by the computing system, a web form data request to the server computing system via an electronic communications network, the computing system receiving the block of web form data in response to the web form data request.

7. The method of claim 6,
wherein receiving the document open request comprises receiving, at the computing system, the document open request from a client computing system, the user interacting with the client computing system; and
wherein the method further comprises after inserting the value into the document element, automatically sending, by the computing system, a copy of the document file to the client computing system in response to the document open request.

8. The method of claim 1, further comprising:
before receiving the block of web form data:
sending, by the computing system, web form data requests to the server computing system via an electronic communications network on a periodic basis, the web form data requests requesting the server computing system to send blocks of web form data to the computing system, the blocks of web form data comprising values submitted to the server computing system via the web form, the blocks of web form data including the block of web form data.

9. The method of claim 1, wherein the document element is visibly differentiated from other parts of the document.

10. The method of claim 1, further comprising:
receiving, at the computing system, web form selection input, the web form selection input specifying the web form;
in response to receiving the web form selection input, updating, at the computing system, the document file to contain form mapping metadata, the form mapping metadata specifying the web form;
causing, by the computing system, a display device to display a list of web form elements in the web form;
after causing the display device to display the list of web form elements, receiving, at the computing system, element selection input, the element selection input indicating that a user has selected the web form element from the list of web form elements; and
in response to receiving the element selection input, updating, at the computing system, the document file to contain the element mapping metadata.

11. The method of claim 10,
wherein the method further comprises:
displaying, at the computing system, at least part of the document in a document application user interface;
receiving, at the computing system, mapping tool open input, the mapping tool open input indicating to the computing system that the user wants the computing system to display a mapping tool, the mapping tool being a user interface that enables the user to map web form elements to document elements in the document; and
in response to receiving the mapping tool open input, automatically causing, by the computing system, the display device to display the mapping tool;
wherein receiving the web form selection input comprises receiving the web form selection input via the mapping tool;
wherein causing the display device to display the list of web form elements comprises automatically causing, by the computing system, the display device to display the list of web form elements in the mapping tool; and
wherein receiving the element selection input comprises receiving, at the computing system, the element selection input via the mapping tool.

12. The method of claim 1, further comprising:
receiving, at the computing system, document creation input from a user, the document creation input indicating that the user wants to create a new document;
in response to receiving the document creation input, automatically generating, at the computing system, the document file;
after generating the document file, receiving, at the computing system, element creation input from the user, the element creation input indicating that the user wants to add a new document element to the document; and
in response to receiving the element creation input, updating, by the computing system, the document file to include the document element.

13. The method of claim 1, further comprising:
after storing the document file and before receiving the block of web form data:
receiving, at the computing system, web form creation input from a user; and
in response to receiving the web form creation input:
automatically creating, by the computing system, the web form;
automatically updating, by the computing system, the document file to include the element mapping metadata;
causing the server computing system to make the web form accessible on an electronic communication network.

14. The method of claim 1,
wherein the method further comprises automatically determining, at the computing system, whether the element mapping metadata indicates that the value is to be appended to data specified by the document element, whether the value is to replace the data specified by the document element, or whether the computing system is to create a new copy of the document file in which the value replaces the data specified by the document element; and
wherein automatically inserting the value into the document element comprises:
automatically replacing, by the computing system, the data specified by the document element with the value when the element mapping metadata indicates that the value is to replace the data specified by the document element;
automatically appending, by the computing system, the value to the data specified by the document element when the element mapping metadata indicates that the value is to be appended to the data specified by the document element; and
automatically creating, by the computing system, the new copy of the document file when the element mapping metadata indicates that the computing system is to create the new copy of the document file in which the value replaces the data specified by the document element.

15. The method of claim 1,
wherein the computing system comprises an electronic computing device, the electronic computing device comprising a computer-readable data storage medium, a processing unit, and a network interface card;
wherein receiving the block of web form data comprises receiving, at the computing system, the block of web form data via the network interface card; and
wherein automatically inserting value into the document element comprises automatically executing, by the processing unit, software instructions stored on the computer-readable data storage medium, the software instructions, when executed by the processing unit, cause the computing system to automatically insert the value into the document element only when the document file comprises the element mapping metadata.

16. A server computing system comprising:
a processing unit; and
a data storage system storing software instructions that, when executed by the processing unit, cause the server computing system to:
receive a block of web form data from a client computing system, the block of web form data comprising a value submitted to the server computing system via a web form, the web form comprising a web form element, the value assigned to the web form element; and
automatically send the block of web form data to a host computing system, the host computing system hosting a document file, the document file comprising data that represents a document, the document being a discrete set of human-readable content, the document comprising a document element, the document element being a logical sub-part of the document, the document file comprising element mapping metadata that maps the document element to the web form element, the host computing system configured to respond to receiving the block of web form data by automatically inserting the value into the document element of the document file.

17. The server computing system of claim 16, wherein the software instructions, when executed by the processing unit, further cause the server computing system to:
receive a web form request from the client computing system, the web form request requesting the web form; and
send, in response to receiving the web form request, the web form to the client computing system.

18. The server computing system of claim 16, wherein the software instructions, when executed by the processing unit, further cause the server computing system to:
store the block of web form data at the data storage system;
receive, after the server computing system stores the block of web form data at the data storage system, a web form data request from the host computing system, the web form data request requesting the server computing system to send the block of web form data to the host computing system; and
send, in response to receiving the web form data request, the block of web form data to the host computing system.

19. The server computing system of claim 16,
wherein the software instructions, when executed by the processing unit, further cause the server computing system to store the block of web form data along with a plurality of blocks of web form data at the data storage system, marking the block of web form data as unsynchronized; and
wherein the software instructions that cause the server computing system to send the block of web form data to the host computing system cause the server computing system to send the block of web form data to the host computing system without first receiving a request from the host computing system for the block of web form data.

20. A computer-readable data storage medium storing software instructions that, when executed by a processing unit of a computing system, cause the computing system to:
receive, at the computing system, document creation input from a user, the document creation input indicating that the user wants to create a word processor document;
in response to receiving the document creation input, generate, at the computing system, a document file comprising data that represents the word processor document, the word processor document being a document comprising human-readable content having a specific format that defines how the human-readable content is laid out when the word processor document is physically printed;
after generating the document file, receive, at the computing system, element creation input from the user, the element creation input indicating that the user wants to add a document element to the word processor document, the document element being a text box within the word processor document, the document element being visibly differentiated from other parts of the word processor document;
in response to receiving the element creation input, update, by the computing system, the document file such that the word processor document includes the document element;
after updating the document file to include the document element, receive, at the computing system, a mapping tool open input, the mapping tool open input indicating that the user wants the computing system to display a mapping tool, the mapping tool being a user interface that enables the user to map web form elements to document elements in the word processor document;
in response to receiving the mapping tool open input, automatically cause, by the computing system, a display device to display the mapping tool;
receive, at the computing system, web form selection input via the mapping tool, the web form selection input specifying a web form;
in response to receiving the web form selection input, automatically update, at the computing system, the document file to contain form mapping metadata, the form mapping metadata specifying the web form;
in response to receiving the web form selection input, automatically identify, by the computing system, web form elements in the web form;
in response to receiving the web form selection input, automatically cause, by the computing system, the display device to display a list of the web form elements in the web form and a list of document elements in the word processor document;
after causing the display device to display the list of web form elements in the web form and the list of document elements in the word processor document, receive, at the computing system, web form element selection input via the mapping tool, the element selection input indicating that the user has selected a web form element from the list of web form elements;
after causing the display device to display the list of web form elements in the web form and the list of document elements in the word processor document, receive, at the computing system, document element selection input via the mapping tool, the document element selection input indicating that the user has selected the document element from the list of document elements in the word processor document;
in response to receiving the element selection input, update, at the computing system, the document file to contain element mapping metadata, the element mapping metadata mapping the document element to the web form element;
save, by the computing system, the document file at a data storage system accessible to the computing system;
receive, at the computing system, a document open request from the user, the document open request indicating that the user wants to open the word processor document;
in response to receiving the document open request, automatically determine, at the computing system, whether the document file comprises the element mapping metadata;
in response to determining that the document file comprises the element mapping metadata, automatically send, by the computing system, a web form data request to a server computing system via an electronic communications network;
receive, at the computing system, a block of web form data from the server computing system, the computing system receiving the block of web form data in response to the web form data request, the block of web form data comprising a value submitted to the server computing system via the web form, the value assigned to the web form element;
determine, at the computing system, whether the element mapping metadata indicates that the value is to be appended to data specified by the document element, whether the value is to replace the data specified by the document element, or whether the computing system is to create a new copy of the document file in which the value replaces the data specified by the document element;
in response to receiving the block of web form data, automatically replace, by the computing system, the data specified by the document element with the value when the element mapping metadata indicates that the value is to replace the data specified by the document element;
automatically append, by the computing system, the value to the data specified by the document element when the element mapping metadata indicates that the value is to be appended to the data specified by the document element;
automatically create, by the computing system, the new copy of the document file when the element mapping metadata indicates that the computing system is to create the new copy of the document file in which the value replaces the data specified by the document element.
